(19) United States
(12) Patent Application Publication
(10) Pub. No.: US 2020/0193740 A1
(43) Pub. Date: Jun. 18, 2020

(54) CALIBRATION METHOD OF THE POSITIONING OF AN ONBOARD DEVICE FOR THE ACQUISITION AND THE REMOTE TRANSMISSION OF DATA RELATING TO MOTION AND DRIVING PARAMETERS OF MOTOR VEHICLES AND MOTORCYCLES

(71) Applicant: OCTO TELEMATICS S.p.A., Rome (IT)

(72) Inventor: Simone SABINA, Rome (IT)

(21) Appl. No.: 16/313,326

(22) PCT Filed: Jun. 30, 2017
(86) PCT No.: PCT/IB2017/053952

§ 371 Date: Dec. 26, 2018

(30) Foreign Application Priority Data
Jul. 1, 2016 (IT) 102016000068808

(51) Int. Cl. G07C 5/08; G07C 5/00; G01P 1/12; G01P 21/00

(52) U.S. Cl. CPC G07C 5/0808; G07C 5/0841; G01P 21/00; G01P 1/127; G07C 5/008

(57) ABSTRACT

A calibration method of the positioning of an onboard device of a vehicle with axes (x, y, z), wherein the device comprises at least one accelerometric sensor (S) which detects the accelerations to which the vehicle is subjected along axes (x′, y′, z′), angularly arranged with respect to the axes (x, y, z) of the vehicle with rotation angles (αx, αy, αz). The accelerometric sensor (S) acquires the acceleration values generated by the force of gravity G acting on the vehicle when the vehicle is stopped. A transformation matrix (R) is determined, wherein a first rotation angle (αx) and a second rotation angle (αy) are derived on the basis of acceleration values of the force of gravity detected along the axes (x′, y′, z′) when the vehicle is stopped, and a third rotation angle (αz) is derived on the basis of the determined travel direction of the vehicle.

### TECHNICAL FIELD

The present invention relates to the technical field of onboard devices for detecting data relating to motion and driving parameters of a transport vehicle. In particular, the present invention relates to a calibration method of the positioning of an onboard device according to the preamble of claim 1.

### BACKGROUND ART

Calibration methods are known in which, during an initial installation step of an onboard device for the acquisition and the remote transmission of data relating to motion and driving parameters of a vehicle, the accelerometric sensor included in or connected to the onboard device must be mounted according to one or more predefined positions (direction and orientation) or positions dependent on the fulfillment of certain conditions.

The accelerometric sensor is able to measure the acceleration along a plurality of axes, usually three, and may be internal to the onboard device or connected to it by means of a wiring or a short-range wireless connection.

In order to represent acceleration variation events of a vehicle, it is necessary to convert the data read by the accelerometric sensor from the Cartesian reference system integral to the sensor itself to a predefined reference system linked to the vehicle, so as to correctly interpret directions and positions of the detected events.

A left-handed, three-axis reference system integral with the vehicle is conventionally considered and the inertial point of view is used, that is, of who is on board the vehicle.

The accelerometric sensor also has three detection axes (x′, y′, z′) and usually has a right-handed configuration. The axes of the accelerometric sensor x′, y′, z′ installed in a non-predefined manner but in the most effective manner to be firmly fixed to the chassis of the vehicle, must therefore be recalibrated one by one so as to be oriented consistently with the left-handed reference system of the vehicle (x, y, z).

The selected vehicle reference system includes three axes arranged as follows:
x axis arranged longitudinally to the vehicle, with positive direction that comes out in the direction of the front part of the vehicle;
y axis arranged transversely to the vehicle, with positive direction that comes out from the left side of the vehicle (driver's side according to Italian vehicles);
z axis arranged vertically, with positive direction that comes out from the lower side of the vehicle, downwards.

To prevent an installer from positioning the accelerometric sensor in an incorrect position, it is known to arrange a control system which prevents the activation of the device if the acceleration values at rest, along the axes of the accelerometric sensor which should be parallel to axes x and y of the vehicle, are not sufficiently low to consider the accelerometric sensor as being positioned exactly horizontally.

The known method described above, understandably, ensures the correct orientation of the z axis but does not ensure the correctness of the determination of its direction, and especially does not ensure the correct orientation of axes x and y.

This limitation does not therefore allow determining with certainty whether an event measured along the x axis or the y axis actually corresponds to an abrupt braking, to an abrupt acceleration or an abrupt curve, and it does not allow properly reconstructing the dynamics of an accident in which the vehicle has been involved.

In addition, the correctness of the installation is only entrusted to the respect of the directions specified by the installer, therefore the installation is not very reliable and requires a long working time by the installer.

Additionally, such a solution needs the accelerometric sensor to be external to the onboard device which would be difficult to install in its entirety with this constraint. The mandatory presence of a wiring is therefore required between the onboard device and the accelerometric sensor, since there are two hardware components to be fixed (onboard device and accelerometer), which increases the installation costs of the apparatus.

Finally, the accelerometric sensor coupled to the onboard device must always be installed according to the same orientation on any vehicle, but this is not always possible.

### SUMMARY OF THE INVENTION

The present invention therefore aims to provide a satisfactory solution to the problems described above, while avoiding the drawbacks of prior art.

According to the present invention, such an object is achieved by a calibration method of the positioning of an onboard device for the detection of data relating to motion and driving parameters of a vehicle having the features recited in claim 1.

Particular embodiments are the subject of the dependent claims, whose content is to be understood as an integral part of the present description.

Further objects of the invention are an onboard device and a computer program as claimed.

In summary, the invention relates to two embodiment variants of a calibration method of the positioning of an onboard device for the acquisition and the remote transmission of data relating to motion and driving parameters of a vehicle including at least one accelerometric sensor, arranged in order to provide accurate indications about the displacement dynamics of the vehicle.

The two variants of the method are based on the same initial mathematical considerations and are specific for motor vehicles and motorcycles.

The variants of the method can be carried out at an elaboration module embedded in the onboard device or at a remote elaboration center. Moreover, variants of installation are also possible for the accelerometric sensor, on board of the onboard device itself or external, but connected thereto via a short-range communication channel of any nature.

The present invention is based on the principle of calibrating the positioning of the onboard device including or associated with an accelerometric sensor installed on a vehicle according to a random orientation, by means of the determination of a transformation matrix (R), adapted to put in relation the accelerations measured along a triad of axes of the coordinate system of the accelerometric sensor x′, y′, z′ with corresponding accelerations along a triad of axes in the vehicle coordinate system x, y, z.

### BRIEF DESCRIPTION OF THE DRAWINGS

Further features and advantages of the invention will appear more clearly from the following detailed description of an embodiment thereof, given by way of non-limiting example with reference to the accompanying drawing, in which:

FIG. 1 shows an exemplary arrangement of a vehicle and an onboard device and the respective detection axes;

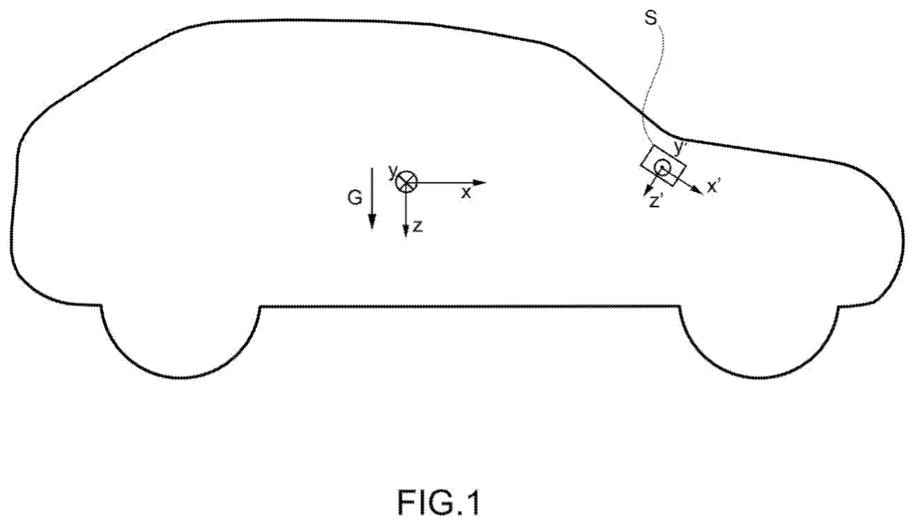

FIG. 2 shows a left-handed reference system for the purposes of mathematical discussion of the calibration method;

FIG. 3 shows the mathematical notation used to describe a rotation of a plane about an axis in the conversion from a first to a second reference system;

FIG. 4 shows a vector of gravity in plane xy in the particular case in which the vehicle is a motorcycle; and

FIG. 5 shows a vector of gravity in plane yz in the particular case in which the vehicle is a motorcycle.

### DETAILED DESCRIPTION

Before explaining a plurality of embodiments of the invention in detail, it should be noted that the invention is not limited in its application to the construction details and to the configuration of the components presented in the following description or shown in the drawings. The invention can take other embodiments and be implemented or practically carried out in different ways. It should also be understood that the phraseology and terminology are for descriptive purpose and are not to be construed as limiting. The use of “include” and “comprise” and variations thereof are intended as including the elements cited thereafter and their equivalents, as well as additional elements and equivalents thereof.

The calibration method of the positioning of an onboard device for the acquisition and the remote transmission of data relating to motion and driving parameters of a vehicle, wherein the device has a first plurality of axes of a reference coordinate system of the vehicle x, y, z and comprises at least one accelerometric sensor S adapted to detect the accelerations to which the vehicle is subjected along a second plurality of axes of a reference coordinate system of the accelerometric sensor x′, y′, z′ angularly arranged with respect to the first plurality of axes x, y, z of the reference coordinate system of the vehicle with a plurality of rotation angles αₓ,α_{y},α_{z}, respectively, comprises the following steps:

In the embodiment described herein, each plurality of axes of the reference coordinate system of the vehicle x, y, z and the plurality of axes of a reference coordinate system of the accelerometric sensor x′, y′, z′ is composed by three axes respectively. The calibration method, although based on the same basic mathematical considerations, differs in the 2 cases of positioning calibration on motor vehicles and motorcycles.

Calibration of the Positioning on Motor Vehicles

A first step consists in acquiring the acceleration values generated by the force of gravity G acting on the vehicle along the axes of the reference coordinate system of the accelerometric sensor x′, y′, z′, when the vehicle is stopped in a substantially horizontal position, by means of the accelerometric sensor S.

A second step consists in acquiring, by means of said accelerometric sensor S, the acceleration values generated by a plurality of events suffered by the vehicle along the axes of the reference coordinate system of the accelerometric sensor x′, y′, z′, whose value exceeds a predetermined acceleration threshold value. This acquisition step takes place in the initial motion phases of the vehicle and the plurality of events consists of a series of abrupt acceleration and braking of the vehicle having a sufficiently high strength to be considered as significant events.

A further step consists in determining the travel direction of the vehicle on the basis of a prevailing direction in which the accelerations generated by the plurality of events suffered by the vehicle along the axes of the reference coordinate system of the accelerometric sensor x′, y′, z′ have been acquired. The plurality of events includes abrupt acceleration, abrupt braking, abrupt turns and vertical stresses suffered by the vehicle.

The method ends with the determination of a transformation matrix R, which puts in relation the accelerations measured along the axes of the coordinate system of the accelerometric sensor x′, y′, z′ with corresponding accelerations along the axes in the coordinate system of the vehicle x, y, z. The matrix comprises the values of the rotation angles αₓ,α_{y},α_{z}, wherein the first rotation angle αₓ and the second rotation angle α_{y} are derived on the basis of acceleration values of the force of gravity detected along the axes of the reference coordinate system of the accelerometric sensor x′, y′, z′ when the vehicle is stopped in a substantially horizontal position, and the third rotation angle α_{z} is derived on the basis of the determined travel direction of the vehicle in the step described above.

αₓ indicates the rotation angle about the x axis; α_{y} indicates the rotation angle about the y axis; α_{z} indicates the rotation angle about the z axis.

Below is a detailed description of a preferred embodiment of the invention.

In order to detect impact or accident events, or acceleration variation events of a vehicle, it is necessary to consider a reference system integral with the vehicle, of left-hand type, using the vehicle point of view (inertial).

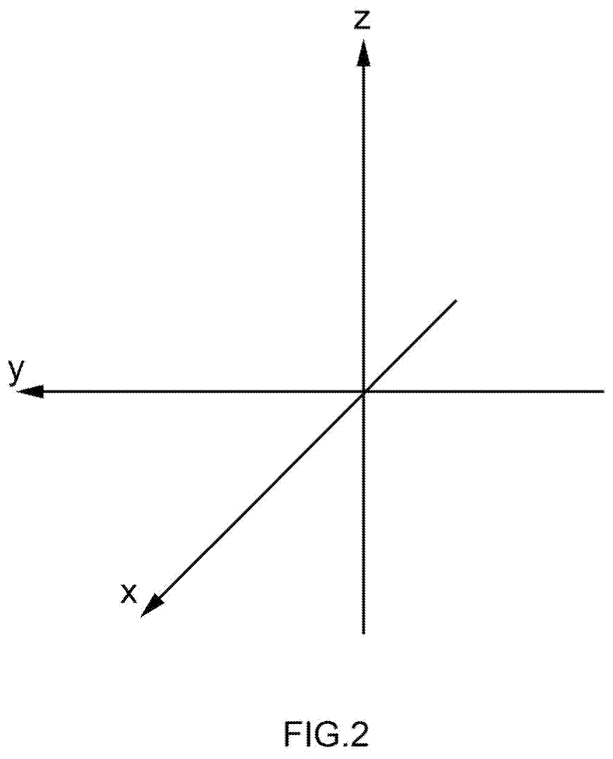

A left-handed system integral with the vehicle is illustrated in FIG. 2.

A three-axis accelerometric sensor is included or at least connected to the onboard device. Said accelerometric sensor has a triad of axes, normally right-handed, which must be reversed one by one to move to the inertial point of view as in the reference system integral with the vehicle.

The reference system integral with the vehicle contemplates the following arrangement of three axes:
x axis arranged longitudinally to the vehicle, with positive direction that comes out in the direction of the front part of the vehicle;
y axis arranged transversely to the vehicle, with positive direction that comes out from the left side of the vehicle (driver's side according to Italian vehicles);
z axis arranged vertically, with positive direction that comes out from the lower side of the vehicle, downwards.

A series of equations must be illustrated to achieve a change of the reference system in space.

Considering the left-handed three-dimensional coordinate space in FIG. 2, a rotation about the z axis by a positive angle (counterclockwise rotation) is equivalent to the rotation of plane xy by an angle α. Point P≡(Pₓ, P_{y}) in the new reference system has coordinates (P_{x′}, P_{y′}).

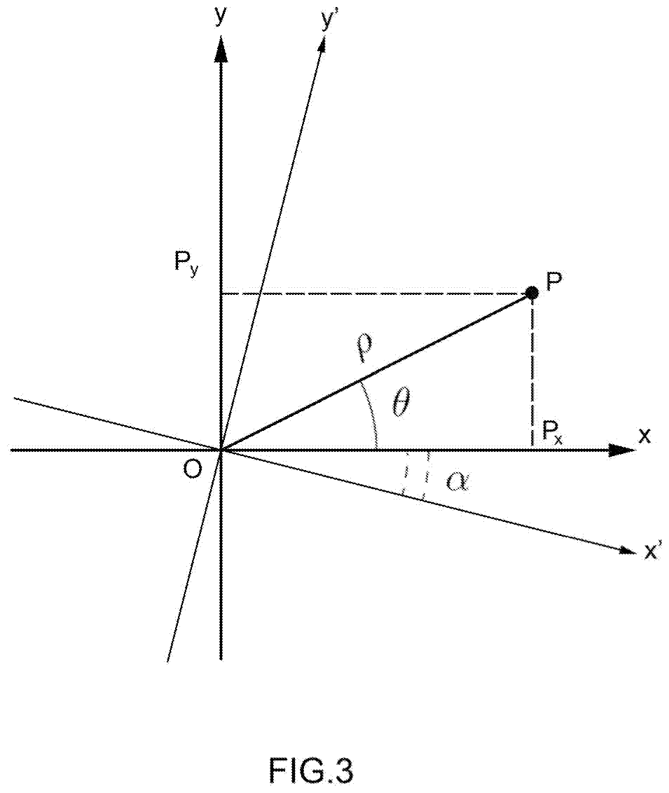

Said rotation is shown in FIG. 3.

Expressing the Cartesian coordinates in polar form:

$$\{ \begin{matrix}{P}_{x} = ρ cos θ \\ {P}_{Y} = ρ sin θ\end{matrix} \qquad ( 1 )$$

The new coordinates (P_{x′}, P_{y′}) are given by:

$$\begin{matrix}\{ \begin{matrix}{P}_{{x}^{′}} = ρ cos ( θ + α ) \\ {P}_{{Y}^{′}} = ρ sin ( θ + α )\end{matrix} & ( 1.2 ) \\ \{ \begin{matrix}{P}_{{x}^{′}} = ρ [ cos θ cos α - sin θ sin α ] = {P}_{x} cos α - {P}_{y} sin α \\ {P}_{{Y}^{′}} = ρ [ sin θ cos α + cos θ sin α ] = {P}_{y} cos α + {P}_{x} sin α\end{matrix} & ( 1.3 )\end{matrix}$$

In matrix form, these relationships become:

$$( \begin{matrix}{P}_{{x}^{′}} \\ {P}_{{y}^{′}}\end{matrix} ) = ( \begin{matrix}cos α & - sin α \\ sin α & cos α\end{matrix} ) ( \begin{matrix}{P}_{x} \\ {P}_{y}\end{matrix} ) \qquad ( 2 )$$

By extending the matrix found in the three-dimensional space:

$$( \begin{matrix}cos α & - sin α & 0 \\ sin α & cos α & 0 \\ 0 & 0 & 1\end{matrix} ) \qquad ( 3 )$$

Likewise, the transformation matrices for the other elementary rotations are determined: rotation about the y axis and a rotation about the x axis.

Any transformation of a three-dimensional Cartesian reference system that has no translational or deforming components can be traced back to a combination of 3 rotations about the axes, composed in a sequential manner. The rotation matrices for each rotation, are:
1. counter clockwise rotation about axis x by an angle αₓ:

$${R}_{x} = ( \begin{matrix}1 & 0 & 0 \\ 0 & cos {α}_{x} & - sin {α}_{x} \\ 0 & sin {α}_{x} & cos {α}_{x}\end{matrix} ) \qquad ( 4 )$$

2. counter clockwise rotation about axis y by an angle α_{y}:

$${R}_{y} = ( \begin{matrix}cos {α}_{y} & 0 & sin {α}_{y} \\ 0 & 1 & 0 \\ - sin {α}_{y} & 0 & cos {α}_{y}\end{matrix} ) \qquad ( 5 )$$

3. counter clockwise rotation about axis z by an angle α_{z}:

$${R}_{z} = ( \begin{matrix}cos {α}_{z} & - sin {α}_{z} & 0 \\ sin {α}_{z} & cos {α}_{z} & 0 \\ 0 & 0 & 1\end{matrix} ) \qquad ( 6 )$$

A method for verifying the correctness of the identified matrices using considerable angles is illustrated hereinafter.

Considering a null rotation, the rotation matrix about the x axis must be the identity and this is actually achieved:

$${α}_{x} = 0 ⇒ {R}_{x} = ( \begin{matrix}1 & 0 & 0 \\ 0 & 1 & 0 \\ 0 & 0 & 1\end{matrix} ) \qquad ( 6.1 )$$

If the rotation is instead by π/2, a simple transformation of the unit vectors must be obtained:

$${α}_{x} = \frac{π}{2} ⇒ {R}_{x} = ( \begin{matrix}1 & 0 & 0 \\ 0 & 0 & - 1 \\ 0 & 1 & 0\end{matrix} ) \qquad ( 6.2 )$$

(1, 0, 0)^{T} becomes (1, 0, 0)^{T}, i.e. the unit vector x₀ remains unchanged, (0, 1, 0)^{T} becomes (0, 0, 1)^{T}, i.e. the unit vector y₀ becomes z₀ in the new reference system, (0, 0, 1)^{T} becomes (0, −1, 0)^{T}, i.e. the unit vector z₀ becomes −y₀; these transformations correspond to what expected, the matrix Rₓ is therefore correct.

Considering a null rotation, the rotation matrix about axis y must be the identity and this is actually achieved:

$${α}_{y} = 0 ⇒ {R}_{y} = ( \begin{matrix}1 & 0 & 0 \\ 0 & 1 & 0 \\ 0 & 0 & 1\end{matrix} ) \qquad ( 6.3 )$$

If the rotation is instead by π/2, a simple transformation of the unit vectors must be obtained:

$${α}_{y} = \frac{π}{2} ⇒ {R}_{y} = ( \begin{matrix}0 & 0 & 1 \\ 0 & 1 & 0 \\ - 1 & 0 & 0\end{matrix} ) \qquad ( 6.4 )$$

(1, 0, 0)^{T} becomes (0, 0, −1)^{T}, i.e. the unit vector x₀ becomes −z₀, (0, 1, 0)^{T} becomes (0, 1, 0)^{T}, i.e. y₀ remains unchanged, (0, 0, 1)^{T} becomes (1, 0, 0)^{T}, i.e. the unit vector z₀ becomes x₀; these transformations correspond to what expected, the matrix R_{y} is therefore correct.

Considering a null rotation, the rotation matrix about axis z must be the identity and this is actually achieved:

$${α}_{z} = 0 ⇒ {R}_{z} = ( \begin{matrix}1 & 0 & 0 \\ 0 & 1 & 0 \\ 0 & 0 & 1\end{matrix} ) \qquad ( 6.5 )$$

If the rotation is instead by π/2, a simple transformation of the unit vectors must be obtained:

$${α}_{z} = \frac{π}{2} ⇒ {R}_{z} = ( \begin{matrix}0 & - 1 & 0 \\ 1 & 0 & 0 \\ 0 & 0 & 1\end{matrix} ) \qquad ( 6.6 )$$

(1, 0, 0)^{T} becomes (0, 1, 0)^{T}, i.e. the unit vector x₀ becomes y₀, (0, 1, 0)^{T} becomes (−1, 0, 0)^{T}, i.e. y₀ becomes −x₀, (0, 0, 1)^{T} becomes (0, 0, 1)^{T}, i.e. the unit vector z₀ remains unchanged.

As mentioned above, a generic rotation in space such as to make a passage between 3 Cartesian reference systems can be obtained as a composition of simple rotations.

Proceeding to the composition of Rₓ and R_{y}, we get:

$${R}_{x} \cdot {R}_{y} = ( \begin{matrix}cos {α}_{y} & 0 & - sin {α}_{y} \\ sin {α}_{x} sin {α}_{y} & cos {α}_{x} & - sin {α}_{x} cos {α}_{y} \\ - cos {α}_{x} sin {α}_{y} & sin {α}_{x} & cos {α}_{x} cos {α}_{y}\end{matrix} ) \qquad ( 6.7 )$$

Instead, the composition of the three single rotations that represents any rotation in space xyz is given by the following rotation matrix

$$( 7 )$$

$$R = {R}_{x} \cdot {R}_{y} \cdot {R}_{z} = ( \begin{matrix}cos {α}_{y} cos {α}_{z} & - cos {α}_{y} sin {α}_{z} & sin {α}_{y} \\ sin {α}_{x} sin {α}_{y} cos {α}_{z} + & - sin {α}_{x} sin {α}_{y} sin {α}_{z} + & - sin {α}_{x} cos {α}_{y} \\ cos {α}_{x} sin {α}_{z} & cos {α}_{x} cos {α}_{z} & \\ - cos {α}_{x} sin {α}_{y} cos {α}_{z} + & cos {α}_{x} sin {α}_{y} sin {α}_{x} + & cos {α}_{x} cos {α}_{y} \\ sin {α}_{x} sin {α}_{z} & sin {α}_{x} cos {α}_{z} & \end{matrix} )$$

Calculating R as Rₓ·R_{y}·R_{z} means applying in a sequence:
rotation about the z axis by an angle α_{z}
rotation about the y axis by an angle α_{y}
rotation about the x axis by an angle αₓ.

The composition of the single rotations is not a commutative operation and to switch from the ideal reference system xyz, integral with the vehicle, to the real reference system z′y′z′, integral with the accelerometric sensor, the following relationship applies:

$$( \begin{matrix}{x}^{′} \\ {y}^{′} \\ {z}^{′}\end{matrix} ) = R ( \begin{matrix}x \\ y \\ z\end{matrix} ) \qquad ( 8 )$$

It should be noted that both triads are left-handed.

In addition, to perform the opposite operation, that is, to convert the measured values in the values integral with the vehicle, the inverse must be calculated. The rotation in space is an isometry (i.e. it preserves angles and modules), therefore R is orthogonal, and then the inverse coincides with the transposed.

$$( 9 )$$

$${R}^{- 1} = {R}^{T} ( \begin{matrix}cos {α}_{y} cos {α}_{z} & sin {α}_{x} sin {α}_{y} cos {α}_{z} + & - cos {α}_{x} sin {α}_{y} cos {α}_{z} + \\ & cos {α}_{x} sin {α}_{z} & sin {α}_{x} sin {α}_{z} \\ - cos {α}_{y} sin {α}_{z} & - sin {α}_{x} sin {α}_{y} sin {α}_{z} + & cos {α}_{x} sin {α}_{y} sin {α}_{z} + \\ & cos {α}_{x} cos {α}_{z} & sin {α}_{x} cos {α}_{z} \\ sin {α}_{y} & - sin {α}_{x} cos {α}_{y} & cos {α}_{x} cos {α}_{y}\end{matrix} )$$

Starting from the rest position of the sensor, it is possible to determine the plane in which it moves, i.e. derive two of the three rotation angles.

At rest, we have: (x₀′, y₀′, z₀′)^{T}=R(0, 0, 1)^{T}, whereby:

x₀=sin α_{y} (10)

y₀′=−sin αₓ cos α_{y} (11)

z₀′=cos αₓ cos α_{y} (12)

The following simple reverse formulas find solutions in the range +/−90°:

$$\begin{matrix}{x}_{0}^{′} = sin {α}_{y} ⇒ {α}_{y} = arc sin {x}_{0}^{′} & ( 13 ) \\ {y}_{0}^{′} = - sin {α}_{x} cos {α}_{y} ⇒ {α}_{x} = - arc sin \frac{{y}_{0}^{′}}{cos {α}_{y}} & ( 14 )\end{matrix}$$

The following formulas, instead, do not have this limitation: by simultaneously using equations (11, 12) dividing member by member, we obtain

$$\frac{{y}_{0}^{′}}{{z}_{0}^{′}} = - tan {α}_{x}$$

whereby:

αₓ=−arctan 2(y₀′,z₀′) (15)

using equations (11) and (12), we calculate:

y₀′²+z₀′²=sin² αₓ cos² α_{y}+cos² αₓ cos² α_{y}=cos² α_{y}

from the previous one and from (10), it follows that:

$$\frac{{x}_{0}^{′}}{\sqrt{{y}_{0}^{{′}^{2}} + {z}_{0}^{{′}^{2}}}} = tan {α}_{y}$$

and so:

α_{y}=atan 2(x₀,\sqrt{y₀′²+z₀′²}) (16)

In the preferred embodiment described herein, the steps of search of plane xy integral with the vehicle and of search of the travel direction are set out in detail.

The search step of plane xy integral with the vehicle occurs when the instrument panel of the vehicle is turned off, and in turn comprises the steps of:
1a) identifying the rest condition: the last 4 average triads of the accelerometric data are analyzed every 15 s (the average is on 20 s recording); if in a certain moment these averages triads differ by less than 100 mg on each axis, then the vehicle is considered in rest conditions and the last average triad is a potential new rest vector.
2a) calculating the rest position (i.e. the gravity vector at rest): if there is no gravity vector at rest already registered in a non-volatile memory associated with the onboard device, the last average triad of the previous step is selected as gravity vector at rest; otherwise, only if the new candidate rest position differs significantly from the current rest position, the current rest position is replaced with the new candidate rest position, as it is assumed that a disassembly and subsequent reassembly of the accelerometric sensor (and consequently of the onboard device, if the sensor is integrated therein) in a different position occurred.
3a) calculating αₓ and α_{y}, using equations (15, 16). The new rest position thus calculated, along with the values of αₓ and α_{y} is saved in the non-volatile memory.

The search step of the travel direction includes the steps of:
1b) considering the accelerometric data (x, y, z) net of the rest vector, calculated in the steps described above;
2b) applying a moving average on 30 samples;
3b) searching the peaks of module R that should correspond to abrupt braking and accelerations, and thus events with predominant component longitudinal to the motion of the vehicle, as follows: with a threshold on R of 120 mg in input at the peak and 180 mg in output (thus with a hysteresis of 30 mg around 150 mg) and a minimum and maximum threshold on the duration (1.5 and 8 seconds, respectively); in the identification step of a peak, calculating also 0 and φ (polar coordinates) of all the acceleration vectors during the peak;
4b) at the end of acceleration peak event, considering it valid and then going to the next step only if:
   a) the acceleration vector step during the peak period is almost constant, that is if the variations of θ and of ϕ are both within 0.8 radians, equal to 45°;
   b) in the case of devices equipped with GNSS receiver, there is a condition of 3D navigation and the following condition is satisfied:

2Δᵥ=|vᵢ−v_{f}|>max(R)*durata*35/2,

where 35=9.8 m/s²*3.6 and the duration is expressed in seconds;
c) projecting max(x, y, z) during the peak in plane xy, namely by applying the rotation with angles αₓ and α_{y} already calculated, component z is less than 60 mg.
5b) collecting a number of significant peaks (20 in case of devices with GNSS, otherwise 30) and starting from these peaks (abrupt acceleration and braking), determining the prevailing direction on plane xy as follows:
   a) grouping the events in two different ways based on the angle with respect to the x axis of plane xy, both based on 24 circular sectors of 15°; group A: one starts from 0° and goes in steps of 15°; group B: one starts from 7.5° and goes in steps of 15°;
   b) counting the events in each subgroup and ordering the subgroups by the sum of the resulting modules;
   c) if the sum of the modules of the first subgroup of the list is greater than the sum of the modules of the second subgroup by a scale factor of at least 1.1, it means that there is a dominant subgroup;
      i. if there is no dominant subgroup on any of its groups, the calculation of angle α_{z} is considered NOT SOLVED and new peaks are collected again;
      ii. if only one group has determined a dominant subgroup, the calculation of angle α_{z} is considered SOLVED and the only dominant subgroup determined is selected for the last step;
      iii. if both groups have determined a dominant subgroup, only if one of the 2 is dominant with respect to the other by a factor of 1.1, the calculation can be considered SOLVED and such a dominant subgroup is considered thereafter, otherwise case i) applies;
   d) α_{z} is given by the weighted average of the vectors that fall in the dominant range determined, where module xy is considered as weight.

### Calibration of the Positioning on Motorcycles

In the particular case in which the vehicle is a motorcycle, all the foregoing considerations are applied up to formula (16), but then one proceeds in a different way to calculate a, as described hereinafter.

By measuring the gravity vector with the motorcycle inclined laterally by an angle γ: (x, y, z)^{T} (0, j, k)^{T}.

j and k may be derived taking into account that the triangle formed by the gravity vector before and after the tilting is isosceles in both reference systems.

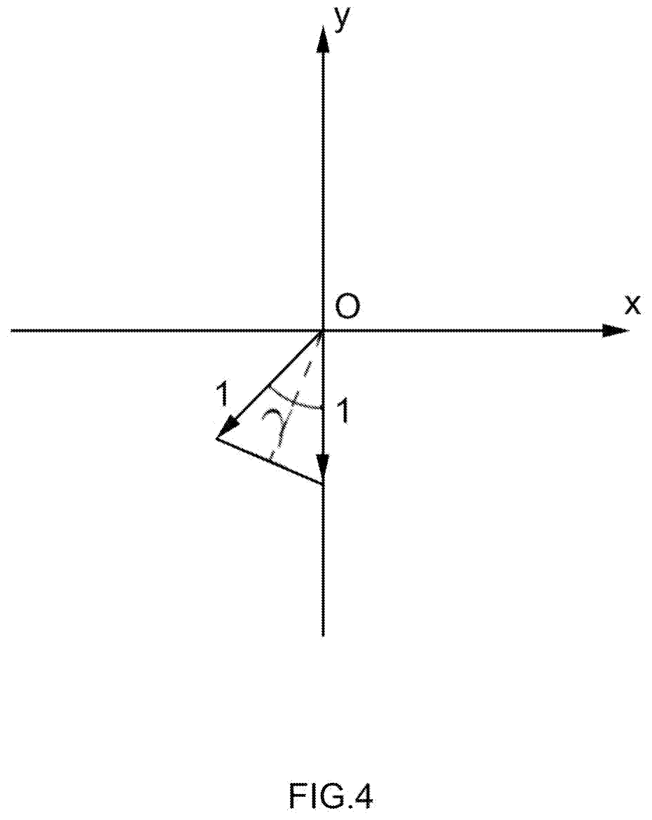

FIG. 4 shows the gravity vector in plane xy.

In particular, considering the measurement system x′, y′, z′ by the accelerometric sensor, the base of the triangle measures:

B=\sqrt{(x₁′−x₀′)²+(y₁′−y₀′)²+(z₁′−z₀′)²} (17)

On the other hand, it is known that

$$\frac{B}{2} = sin \frac{γ}{2} ⇒ γ = 2 arcsin \frac{B}{2} = 2 arcsin \frac{\sqrt{{( {x}_{1}^{′} - {x}_{0}^{′} )}^{2} + {( {y}_{1}^{′} - {y}_{0}^{′} )}^{2} + {( {z}_{1}^{′} - {z}_{0}^{′} )}^{2}}}{2} \qquad ( 18 )$$

Therefore, j is sin γ and k equal to −cos γ.

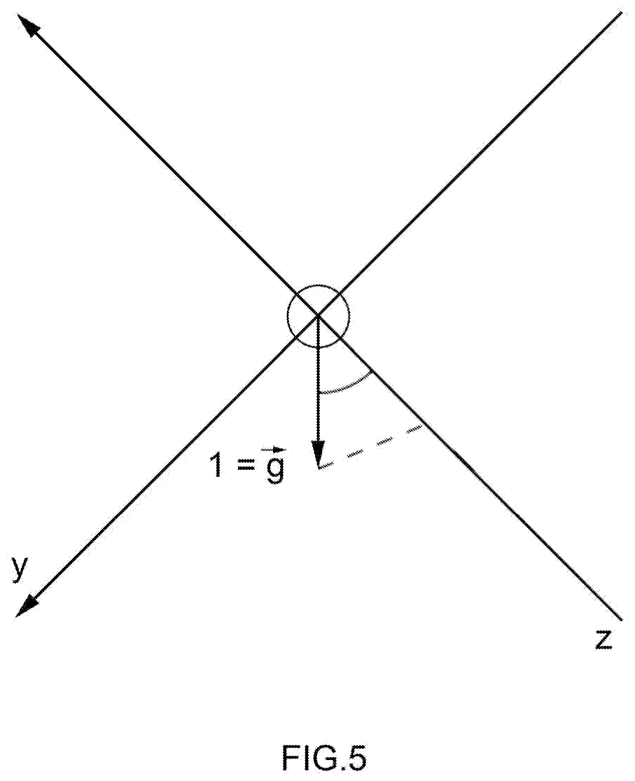

FIG. 5 shows the gravity vector in plane yz.

From relationship

$$( \begin{matrix}{x}_{1}^{′} \\ {y}_{1}^{′} \\ {z}_{1}^{′}\end{matrix} ) = R ( \begin{matrix}0 \\ j \\ k\end{matrix} ) \qquad ( 19 )$$

it follows that x₁′=−j cos α_{y} sin α_{z}+k sin α_{y}, from which we derive

$${α}_{z} = arc sin \frac{- {x}_{1}^{′} + sin {α}_{y} k}{cos {α}_{y} j} .$$

To summarize:
measurement in the rest position (x₀′, y₀′, z₀′) from which we derive:

$$\begin{matrix}{α}_{z} = arc sin {x}_{0}^{′} & ( 19.2 ) \\ {α}_{x} = arc sin ( \frac{- {y}_{0}^{′}}{cos {α}_{y}} ) & ( 19.3 )\end{matrix}$$

measurement with motorcycle inclined laterally by an angle γ(x₁′, y₁′, z₁′) from which we derive:

$$\begin{matrix}γ = 2 arc sin \frac{\sqrt{{( {x}_{1}^{′} - {x}_{0}^{′} )}^{2} + {( {y}_{1}^{′} - {y}_{0}^{′} )}^{2} + {( {z}_{1}^{′} - {z}_{0}^{′} )}^{2}}}{2} , & ( 19.6 ) \\ j = sin γ , k = cos γ & \end{matrix}$$

and then:

$${α}_{z} = arc sin ( \frac{- {x}_{1}^{′} + sin {α}_{y} k}{cos {α}_{y} j} ) \qquad ( 19.5 )$$

calculation of the complete matrix R to convert the data integral with the motorcycle in the measured data.

It should be noted that the proposed embodiment for the present invention in the foregoing discussion has a purely illustrative and non-limiting nature of the present invention. A man skilled in the art can easily implement the present invention in different embodiments which however do not depart from the principles outlined herein and are therefore included in the present patent.

Finally, the invention also relates to a computer program, in particular a computer program on or in an information medium or memory, adapted to implement the method of the invention. This program can use any programming language, and be in the form of source code, object code, or intermediate code between source code and object code, for example in a partially compiled form, or in any other desired form in order to implement a method according to the invention.

The information medium may be any entity or device capable of storing the program. For example, the medium may comprise a storage medium, such as a ROM, for example a CD ROM or a microelectronic circuit ROM, or a magnetic recording medium, such as a floppy disk or a hard disk.

On the other hand, the information medium may be a medium that can be transmitted, such as an electrical or optical signal, which can be routed through an electrical or optical cable, by radio signals or by other means. The program according to the invention may in particular be downloaded over an Internet type network.

Of course, the principle of the invention being understood, the manufacturing details and the embodiments may widely vary compared to what described and illustrated by way of a non-limiting example only, without departing from the scope of the invention as defined in the appended claims.

1. A calibration method of the positioning of an onboard device for the acquisition and the remote transmission of data relating to motion and driving parameters of a vehicle having a first plurality of axes of a reference coordinate system of the vehicle (x, y, z), wherein said onboard device comprises at least one accelerometric sensor (S) adapted to detect the accelerations to which the vehicle is subjected along a second plurality of axes of a reference coordinate system of the accelerometric sensor (x′, y′, z′), the second plurality of axes (x′, y′, z′) of the accelerometric sensor (S) being angularly arranged with respect to the first plurality of axes (x, y, z) of the reference coordinate system of the vehicle with a plurality of rotation angles (αₓ, α_{y}, α_{z}) respectively; said method being characterized in that it comprises:
when the vehicle is stopped in a substantially horizontal position, acquiring the acceleration values generated by the force of gravity, G, acting on the vehicle along the second plurality of axes of the reference coordinate system of the accelerometric sensor (x′, y′, z′), by means of said accelerometric sensor (S);
acquiring, by means of said accelerometric sensor (s), the acceleration values generated by a plurality of events suffered by the vehicle along the second plurality of axes of the reference coordinate system of the accelerometric sensor (x′, y′, z′), whose acceleration exceeds a predetermined threshold value;
determining a travel direction of the vehicle on the basis of a prevailing direction in which the accelerations generated by a plurality of events suffered by the vehicle along the second plurality of axes of the reference coordinate system of the accelerometric sensor (x′, y′, z′) have been acquired;
said method determining a transformation matrix (R), adapted to put in relation the accelerations measured along the second plurality of axes of the coordinate system of the accelerometric sensor (x′, y′, z′) with corresponding accelerations along the first plurality of axes in the coordinate system of the vehicle (x, y, z), wherein a first rotation angle (αₓ) and a second rotation angle (α_{y}) are derived on the basis of acceleration values of the force of gravity detected along the second plurality of axes of the reference coordinate system of the accelerometric sensor (x′, y′, z′) when the vehicle is stopped in a substantially horizontal position, and a third rotation angle (α_{z}) is derived on the basis of the determined travel direction of the vehicle.

2. A calibration method according to claim 1, wherein the step of acquiring by means of said accelerometric sensor (S) the accelerations generated by a plurality of events suffered by the vehicle along the second plurality of axes of the reference coordinate system of the accelerometric sensor (x′, y′, z′), the value of which exceeds a predetermined acceleration threshold value, takes place in a first phase of motion of the vehicle.

3. A calibration method according to claim 1, wherein both the first plurality of axes of the reference coordinate system of the vehicle (x, y, z) and the second plurality of axes of the reference coordinate system of the accelerometric sensor (x′, y′, z′) comprise three axes respectively.

4. A calibration method according claim 1, wherein the plurality of events suffered by the vehicle along the second plurality of axes of the reference coordinate system of the accelerometric sensor (x′, y′, z′), acquired by said accelerometric sensor (S), comprises abrupt acceleration events and abrupt braking events suffered by the vehicle.

5. A method according to claim 1, wherein the accelerometric sensor (S) is a three-axis accelerometer.

6. An onboard device of a vehicle, comprising an elaboration module programmed to implement a method according to claim 1.

7. A computer program executable by an elaboration module of an onboard device of a vehicle, adapted to implement a calibration method of the invention according to claim 1.
